(19) United States
(12) Patent Application Publication
(10) Pub. No.: US 2014/0127521 A1
(43) Pub. Date: May 8, 2014

(54) COMPOSITE MOLDED BODY AND METHOD FOR PRODUCING SAME

(71) Applicants: Soichi Ishibashi, Chuo-ku (JP); Masayuki Koshi, Nagoya-shi (JP)

(72) Inventors: Soichi Ishibashi, Chuo-ku (JP); Masayuki Koshi, Nagoya-shi (JP)

(73) Assignee: Toray Industries, Inc., Tokyo (JP)

(21) Appl. No.: 14/009,893

(22) PCT Filed: Feb. 23, 2012
(86) PCT No.: PCT/JP2012/054345

§ 371 Date: Nov. 15, 2013

(30) Foreign Application Priority Data
Apr. 5, 2011 (JP) 2011-083597

(51) Int. Cl. B29C 65/02; B32B 27/28; B32B 27/34

(52) U.S. Cl. CPC B29C 65/02; B32B 27/34; B32B 27/28
USPC 428/474.7; 156/322; 428/515

(57) ABSTRACT

A method of producing a composite molded body including joining a pre-molded preform (a) and a preform (b) with a fiber-reinforced thermoplastic resin by (1) providing reinforcing fibers having a weight average fiber length of 1 mm or more in at least one of the preforms (a) and (b), (2) using a thermoplastic resin (A) for the preform (a) and using the thermoplastic resin (A) or a thermoplastic resin (B) for the preform (b), (3) forming a thin film of a thermoplastic resin (C) on a surface of either the preform (a) or (b), or on surfaces of preforms (a) and (b), and (4) melting the thermoplastic resin (C) and a part of the preforms (a) and (b) by heating such that the thin film is placed at a boundary surface of a joint, and molding the composite molded body by the joint due to the melting.

### TECHNICAL FIELD

This disclosure relates to a composite molded body and a method of producing the same and, specifically, to a method of producing a composite molded body which molds a composite molded body with pre-molding preforms with predetermined shapes which comprise fiber-reinforced resins using thermoplastic resins, melting a part of the preforms by heating, and joining the preforms to each other at the molten part, and a composite molded body produced by the method.

### BACKGROUND

A method of joining a fiber-reinforced resin of a thermosetting resin and a fiber-reinforced resin of a thermoplastic resin and producing a composite molded body made of a fiber-reinforced resin as a whole is known (for example, JP-B-3906319 and JP-B-4543696). The thermoplastic resin itself and the fiber-reinforced resin using the thermoplastic resin are excellent in moldability and mass productivity as compared to the thermosetting resin and the fiber-reinforced resin using the same, because injection molding can be carried out relatively easily. Therefore, in particular in production of mass products and the like, a method of producing a composite molded body which can efficiently join fiber-reinforced resins using thermoplastic resins to each other is required.

As such a method of producing a composite molded body, for example, the following method is considered. Namely, a method is considered for preparing at least two kinds of fiber-reinforced resin products using thermoplastic resins which are formed by press molding or injection molding (for example, a fiber-reinforced resin product using a polyphenylene sulfide (PPS), this is called as a preform or a primary molded product.), press contacting the preforms to each other while heating them by some means such as direct heating, vibration or ultrasonic waves, melting a part of the preforms, and forming a composite molded body by the joint due to the welding. By such a so-called “fusing” bonding, it is possible to obtain, for example, a hollow structure or a composite molded body as a final molded product in which ribs and the like are equipped and which exhibits satisfactory strength and stiffness together.

However, in the above-described preforms using, for example, a usual PPS grade, because the crystallization speed of the PPS resin is relatively high, as a result, the solidification at the time of cooling from the molten condition is fast. As a result, even if the surface of the preform is molten by giving a certain amount of heat, because the solidification occurs quickly before proceeding with a step for achieving a good fusion such as press contacting, a joint strength capable of meeting an expectation cannot be obtained. Therefore, there is a fear that the strength and stiffness of a composite molded body as a final molded product do not reach target values.

Accordingly, it would be helpful to provide a method in which, when producing a composite molded body of a fiber-reinforced resin using a thermoplastic resin and excellent in moldability and mass production, pre-molded preforms are joined by fusing bonding to each other at a sufficiently high joint strength, and a composite molded body as a final molded product excellent in strength and stiffness can be produced efficiently, and a composite molded body produced by the method.

### SUMMARY

We provide a method of producing a composite molded body wherein a composite molded body is molded by joining a preform (a) pre-molded using a fiber-reinforced thermoplastic resin and a preform (b) pre-molded using a fiber-reinforced thermoplastic resin including (1) providing reinforcing fibers having a weight average fiber length of 1 mm or more in at least one of the preforms (a) and (b), (2) using a thermoplastic resin (A) for the preform (a) and using the thermoplastic resin (A) or a thermoplastic resin (B) for the preform (b), (3) forming a thin film of a thermoplastic resin (C) on a surface of either the preform (a) or (b), or on surfaces of both of the preforms (a) and (b), and (4) melting the thermoplastic resin (C) and a part of the preforms (a) and (b) by heating at a condition where the thin film of the thermoplastic resin (C) is placed at a boundary surface of a joint, and molding the composite molded body by the joint due to the melting.

### BRIEF DESCRIPTION OF THE DRAWINGS

FIG. 1 is a schematic diagram showing an example of a method of producing a composite molded body.

FIG. 2 is a diagram showing general relationships between a fiber length of reinforcing fibers and properties and moldability of a composite.

### EXPLANATION OF SYMBOLS

1: preform (a)
2: preform (b)
3: layer of thermoplastic rein (C)
4: composite molded body

### DETAILED DESCRIPTION

We thus provide a method wherein a composite molded body is molded by joining a preform (a) pre-molded using a fiber-reinforced thermoplastic resin and a preform (b) pre-molded using a fiber-reinforced thermoplastic resin, comprising:
(1) containing reinforcing fibers having a weight average fiber length of 1 mm or more in at least one of the preforms (a) and (b);
(2) using a thermoplastic resin (A) for the preform (a) and using the thermoplastic resin (A) or a thermoplastic resin (B) for the preform (b);
(3) forming a thin film of a thermoplastic resin (C) on a surface of either the preform (a) or (b), or on surfaces of both of the preforms (a) and (b); and
(4) melting the thermoplastic resin (C) and a part of the preforms (a) and (b) by heating at a condition where the thin film of the thermoplastic resin (C) is placed at a boundary surface of joint, and molding the composite molded body by joint due to the melting.

As the above-described preform containing reinforcing fibers having a weight average fiber length of 1 mm or more, for example, either
(1) a molded body with a combination of a mat base material substantially randomly oriented with reinforcing fibers having a weight average fiber length of 1 mm to 50 mm and a thermoplastic resin; or
(2) a molded body reinforced so that continuous fibers are arranged to be extended between arbitrary two end parts of the preform, or
   a molded body combined therewith can be employed. Namely, in a molded product of a fiber-reinforced resin using a thermoplastic resin, to realize exhibition of high mechanical properties required for, for example, structural materials, because it becomes necessary that the fiber length of reinforcing fibers is great, a molded product is preferred to use reinforcing fibers having a weight average fiber length of 1 mm or more, in particular, in consideration of moldability and the like, it is preferred to use a reinforcing fiber base material of reinforcing fibers having a weight average fiber length of 1 mm to 50 mm, and preferred is a molded body with a combination of a mat base material substantially randomly oriented with reinforcing fibers having a fiber length in this range and a thermoplastic resin. Alternatively, a molded body reinforced so that reinforcing fibers formed as continuous fibers are arranged to be extended between arbitrary two end parts (for example, between two end parts of two sides facing each other) of the preform is also preferred. Furthermore, a molded body combined with those can also be employed.

As described above, it is preferred to use a molded body which is reinforced so that continuous fibers are arranged to be extended between arbitrary two end parts, as the preform. In such a case, highest mechanical properties can be obtained without cutting of fibers when certain reinforcing fibers are used. If the preform reinforced by the continuous fibers is disposed as a skeletal structure, in a composite integrated molded product, high mechanical properties and a complicated shape can be both realized.

In a case where discontinuous reinforcing fibers are used as the reinforcing fibers of the preform, it is preferred that they are reinforcing fibers having a weight average fiber length of 1 mm to 50 mm as described above. If the weight average fiber length is less than 1 mm, the characteristics of the reinforcing fibers cannot be extracted and required high mechanical properties cannot be exhibited. If the weight average fiber length exceeds 50 mm, good formability, that is one feature when discontinuous reinforcing fibers are employed, is damaged.

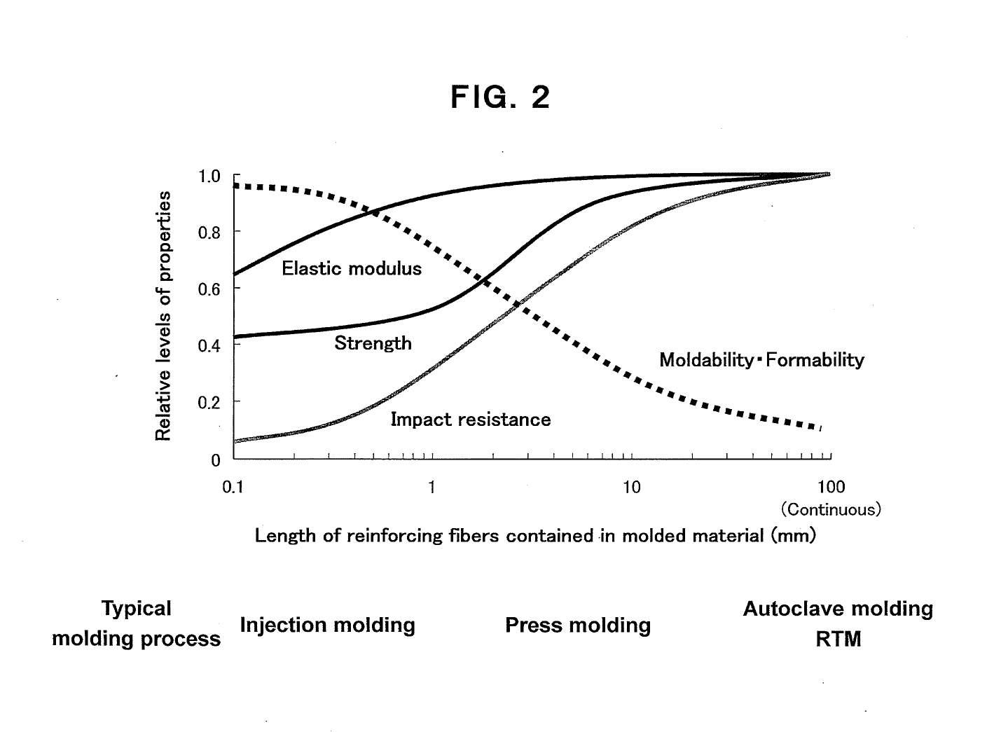

Further, in a case where a mechanical property, in particular, such as impact resistance is important, in the above-described preform containing reinforcing fibers having a weight average fiber length of 1 mm or more, a range of 20 mm to 50 mm for the weight average fiber length of the reinforcing fibers can be indicated as a more preferable range. This is because the fiber length greatly influences contribution to increase of mechanical properties such as impact resistance as shown in FIG. 2.

The orientation and other characteristics of the discontinuous fibers are not particularly restricted and a substantially random orientation can be employed. As a range of this “substantially random,” a sheet-like mat dispersed with fibers at an isotropic condition in plane or having a gentle constant orientation can be exemplified, and a mat prepared by a known fibrous mat production process such as paper making process, carding process or air laid process can be used.

Further, preferably at least a surface layer part of the above-described preform containing reinforcing fibers having a weight average fiber length of 1 mm or more contains a layer in which reinforcing fibers made of continuous fibers are oriented in one direction.

For the above-described thermoplastic resin (A), thermoplastic resin (B) and thermoplastic resin (C), thermoplastic resins prescribed differently from each other (namely, they are same kind of thermoplastic resins, but are thermoplastic resins prepared by prescriptions different from each other so that their properties and characteristics are different from each other) are used. Because of joint formation of thermoplastic resins to each other, essentially a good joint state can be easily obtained. Further, recycling can be easily carried out by crushing of the whole of a molded product. Since preforms are molded in advance even though thermoplastic resins are joined to each other, it is helpful to provide a high joint strength between the thermoplastic resin (C) forming a surface layer part of a preform and the thermoplastic resin (A) or the thermoplastic resin (B) and, in particular, to achieve this, the following example can be employed. For example, it can be the above-described thermoplastic resin (A), thermoplastic resin (B) and thermoplastic resin (C) having a main component of a crystalline thermoplastic resin, and satisfying:

crystallization temperature of thermoplastic resin (C)<crystallization temperature of thermoplastic resin (A), and

crystallization temperature of thermoplastic resin (C)<crystallization temperature of thermoplastic resin (B).

Thus, by providing differences with high and low to the crystallization temperatures, in particular, it becomes possible to lower the crystallization speed by making the crystallization temperature of the thermoplastic resin (C) positioned at the boundary surface of the joint relatively low (the higher the crystallization temperature is, the higher the crystallization speed is), and when the boundary surface is heated by vibration and the like, the thermoplastic resin (C) at the boundary surface can be sufficiently molten before crystallization, and the time to become attached to the boundary surface can be obtained by press contact of the preforms to each other and the like. By this, in the combination of the preforms using the thermoplastic resin (A) or the thermoplastic resin (B) with each other, it becomes possible to produce a composite molded body joined with a high joint strength. With the determination of this crystallization temperature (Tc), by determining a crystallization exothermic peak temperature [crystallization temperature (Tc)] of a target resin by cooling the target resin from a molten condition at a constant speed (10° C./min.) by a differential scanning calorimeter (DSC), the above-described crystallization speed is estimated (the higher the crystallization temperature (Tc) is, the higher the crystallization speed is).

Further, to satisfy the above-described properties of the crystallization temperatures, or separately from the above-described properties of the crystallization temperatures, it is possible to employ the above-described thermoplastic resin (A) and thermoplastic resin (B) that are a thermoplastic resin made of a homopolymer polymerized with a specified monomer, and the above-described thermoplastic resin (C) which is a thermoplastic resin made of a copolymer copolymerized with two or more different-kind monomers and contains the same monomer as a monomer in the thermoplastic resin (A) or the thermoplastic resin (B) as one of the two or more monomers, or a resin composition blended with the copolymer. In such a case, it becomes possible to make the crystallization temperature of the thermoplastic resin (C) side low as compared to that of the thermoplastic resin (A) or the thermoplastic resin (B) side, the thermoplastic resin (C) with the low crystallization temperature contacts with the thermoplastic resin (A) and the thermoplastic resin (B) at a molten condition for a longer period of time, and it becomes possible to achieve a high-strength joint with the thermoplastic resin (A) or the thermoplastic resin (B) (between the preform (a) and the preform (b)). Namely, it becomes possible to produce a composite molded body joined with a high joint strength.

It is possible to lower the crystallization speed of the whole system by lowering the crystallization temperatures of all resins of the thermoplastic resin (A), the thermoplastic resin (B) and the thermoplastic resin (C). However, if a special manner of lowering a crystallization temperature is employed relative to the whole system, increased cost cannot be avoided and, therefore, this method is not considered to be an advantageous method industrially. By using the thermoplastic resin (C) relatively low in crystallization temperature only at the boundary surface of the joint, a sufficient joint strength between both resins can be obtained and a great cost increase can be avoided.

As the above-described boundary layer of the joint part (intermediate layer), for example, a film or a nonwoven fabric due to melt blow or spun bond, using the thermoplastic resin (C), can be used. This is disposed on either the preform (a) or the preform (b), or on the surfaces of both the preform (a) and the preform (b). For example, when a preform is obtained beforehand by pressing and the like, it is preferred to place it on the surface and integrate it in advance. In this case, even if the thermoplastic resin (C) and the thermoplastic resin (A) or the thermoplastic resin (B) are partially mixed, at least a part of the thermoplastic resin (C) may be exposed on the surface.

As a method of joining the preform (a) and the preform (b) in the method of producing a composite molded body, for example, the following methods can be used. Examples include vibration welding (method wherein the resins are welded to each other by melting the resins by utilizing a friction heat generated at the joint boundary surface between two kinds of preforms), hot plate fusing bonding (technology wherein preforms to be welded are heated by contact or non-contact condition of a hot plate heated in advance, and after the joint surfaces become molten condition, two kinds of preforms are pressed to be welded), impulse fusing bonding (method of fusing bonding using a heat source in which a low voltage and a great current are applied to a heater wire for a short period of time to get an exothermic condition), high-frequency fusing bonding (method of fusing bonding for generating an internal heat in a material to be joined (conductive material) by utilizing a high-frequency induction heating), ultrasonic fusing bonding (method for elevating in temperature a preform locally and momentarily by a friction heat generated by giving a vertical ultrasonic vibration to the preform) and the like. Other than those, known heating methods can be used such as a method of flowing an inductive current to a conductive material (for example, carbon fibers) by electromagnetic induction heating to heat it by Joule heat, a method of directly flowing a current to a conductive material (for example, carbon fibers) to heat it by Joule heat, and methods due to hot air, a torch or a laser.

In the method of producing a composite molded body, as more concrete combinations of the thermoplastic resin (A), the thermoplastic resin (B) and the thermoplastic resin (C), for example, the following combinations can be exemplified. An example includes a combination wherein the thermoplastic resin (A) and the thermoplastic resin (B) have a main component of a polyphenylene sulfide, and the thermoplastic resin (C) comprises a copolymerized polyphenylene sulfide. In this case, as the copolymerized polyphenylene sulfide, a polymer copolymerized with m-phenylene sulfide unit to p-phenylene sulfide unit can be used.

Polyphenylene sulfide is one of the most preferable components. Polyphenylene sulfide is a polymer having a stiff frame and has a high stiffness, and exhibits high mechanical properties by a combination with reinforcing fibers such as carbon fibers. Therefore, even if the weight average fiber length of the reinforcing fibers is shortish to be 1 mm to 20 mm, it exhibits relatively high mechanical properties. Further, in a case where the fiber length is longer or continuous reinforcing fibers are used, it exhibits better properties. Further, it has a flame retarding property, and is suitable for uses requiring flame retardance such as various electronic equipment or electric parts for vehicles. Furthermore, although usual polyphenylene sulfide comprising mainly p-polyphenylene sulfide is high in crystallization speed and is a group usually difficult with composite integration molding, by applying our methods, for example, by using a resin group lowering the crystallization temperature (lowering the crystallization speed) for the thermoplastic resin (C), a composite molded body high in joint strength can be obtained.

Further, as another combination, the thermoplastic resin (A) and the thermoplastic resin (B) comprise a polyamide, and the thermoplastic resin (C) comprises a copolymerized polyamide can also be employed.

The combinations of the thermoplastic resin (A), the thermoplastic resin (B) and the thermoplastic resin (C) is not limited to the above-described examples. The crystallization temperature of the thermoplastic resin (C) side is desired to be low as compared to that of the thermoplastic resin (A) side or the thermoplastic resin (B) side, and the method of realizing this also is not restricted. As the method of changing the crystallization temperature of a polymer, known methods can be utilized, and other than the above-described method using a copolymer, the crystallization temperature can be controlled by adding various additives such as talc, kaolin, an organic phosphorus compound, a specified polymer at a small amount. Further, it is also possible to change the crystallization temperature by setting the end groups of the main polymer chains of the thermoplastic resin (A), the thermoplastic resin (B) and the thermoplastic resin (C) to specified groups.

Further, in the method of producing a composite molded body, the kind of the reinforcing fibers used is not particularly restricted, carbon fibers, glass fibers, aramide fibers and the like can be used, and a hybrid structure combining those can also be employed. In a case of achieving easiness of design of strength, easiness of production and the like in the production of the composite molded body, in particular, an example containing carbon fibers is preferred. In particular, if carbon fibers are used as the reinforcing fibers of the preform using continuous fibers, high characteristics of the reinforcing fibers can be exhibited most strongly.

A composite molded body produced by the above-described method is also provided. The shape and structure of the composite molded body to be produced are not particularly restricted. With the fused part between the preform (a) and the preform (b), it is desirable to ensure a broad area as long as the shape allows. A fitting shape can be employed. As at least one of the preforms, exemplified is a preform obtained by injecting a pellet-like material using a usual injection molding machine. Moreover, a molding method performing an operation resembling thereto can also be used. For example, so-called “injection press” molding combining operations of injection and pressing can be used. Pellets used for injection molding or technologies resembling thereto may be usual compound pellets and may be so-called “long-fiber” pellets.

Thus, in the method of producing a composite molded body, when the preform (a) and the preform (b) are joined, since the thermoplastic resin (C) forming the surface layer parts of the preforms and the thermoplastic resins (A) and (B) are set to be same kind of thermoplastic resins but are thermoplastic resins prepared by prescriptions different from each other so that the crystallization speed of the thermoplastic resin (C) is set to be relatively low, the thermoplastic resin (C) contacts with the thermoplastic resin (A) and the thermoplastic resin (B) at a molten condition for a longer period of time, and a high-strength joint with the resin (A) or the resin (B) (between the preform (a) and the preform (b)) can be achieved. The composite molded body thus produced has high mechanical strength and stiffness. Further, because it is a body joined with same kind of thermoplastic resins, it can also have an excellent recycling property.

Hereinafter, examples of our molded bodies and methods will be explained referring to the figures.

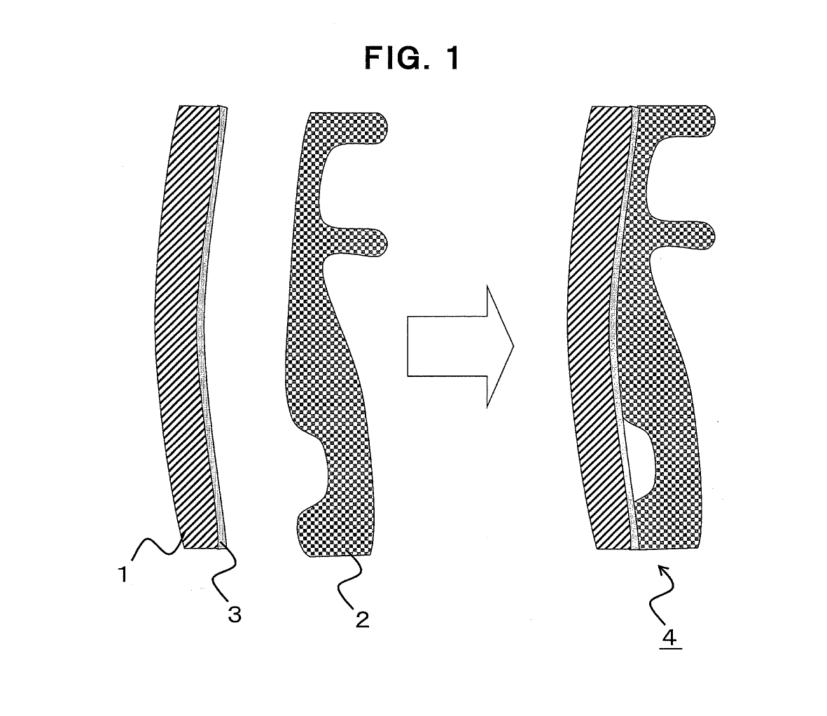

FIG. 1 shows examples of a method of producing a composite molded body and preforms. In FIG. 1, symbol 1 indicates a preform (a) and symbol 2 indicates a preform (b). Further, symbol 3 indicates a layer using a thermoplastic resin (C) having a relatively lower crystallization temperature (for example, a low crystallization-temperature PPS [a low crystallization-temperature copolymerized polyphenylene sulfide]). The layer 3 of thermoplastic resin (C) is integrally molded in advance on one surface of preform (a) (1). Each of preform (a) (1) and preform (b) (2) comprises a fiber-reinforced resin using a thermoplastic resin (A) or a thermoplastic resin (B) (for example, PPS having a usual crystallization temperature) which has a crystallization temperature relatively higher than that of thermoplastic resin (C).

The above-described preform (a) (1) and preform (b) (2) are formed into a composite molded body 4 by melting a part of the preforms to join them by the melting by press contacting the preforms to each other while heating them by an appropriate means such as direct heating, vibration or ultrasonic means. By such a so-called “fusion,” for example, composite molded body 4 as a final molded product, which is formed in a hollow structure or which is disposed with ribs and the like and has both of strength and stiffness, can be obtained.

A case is also considered where the resin used for preform (b) (2) is the thermoplastic resin (B) different from the thermoplastic resin (A). Further, both cases where the layer 3 of thermoplastic resin (C) is formed in advance on the surface of preform (a) (1) and where it is formed on the surface of preform (b) (2) can be employed as long as the thermoplastic resin (C) exists on the fusion surface. The layer 3 of thermoplastic resin (C) may be formed on the surfaces of both preform (a) (1) and preform (b) (2).

The above-described preform (a) and preform (b) are obtained by a molding method such as press molding or injection molding, and the molding method is not particularly restricted. In a case using press molding, a preform having a predetermined shape may be molded by using a so-called “thermoplastic prepreg,” prepared by compounding or impregnating a thermoplastic resin into, for example, a continuous fiber base material such as a woven fabric, a base material arranged with fibers in one direction (a unidirectional base material [UD]) or a long-fiber mat, as a raw material, placing it in a mold and heating and pressing it. At that time, for example, by pressing after disposing a layer such as a film or a nonwoven fabric, which becomes the thermoplastic resin (C), as the lowermost layer or the uppermost layer in a mold in advance, they can be integrated. Further, also in a case of injection molding, molding can be carried out by a method such as insert molding for injection molding after disposing a layer such as a film or a nonwoven fabric, which becomes the thermoplastic resin (C), in a cavity of a mold in advance, or after disposing a thermoplastic prepreg in a cavity in advance. Other than these, known thermoplastic resin molding technologies such as injection press molding, vacuum molding, blow molding, autoclave molding and diaphragm molding can be utilized to prepare a preform. The preform is processed into a composite molded body usually by being cooled for the purpose of being taken out from a mold after primary molding, and thereafter, being heated again and joined to make the composite molded body. A total production line and the like can also be exemplified wherein, while the preform (a) and the preform (b) are being molded by molding machines separate from each other, respectively, they are automatically joined at a following process. Of course, if the molding cycles of the preform (a) and the preform (b) are different from each other, an independent joining/processing line may be constructed.

Freedom of shape and design of a composite molded body can be drastically increased by a condition where the preforms can be freely joined and compounded to each other with a good joint strength. For example, a hollow structure and the like, which is difficult to obtain by a usual injection molding, can be easily realized. Further, a complicated shape and a high mechanical property can be both realized, for example, by molding a face plate part having a gentle curved surface by using a continuous fiber-reinforced prepreg (preform (a)) and thereto joining a complicated shape injection molded product having ribs and the like for reinforcement (preform (b)). In this case, if joined to adequately form a hollow part, further a property for lightening in weight can also be improved greatly. The preforms (a) and (b) and the raw materials to be used and shapes therefor can be freely set within the range of the application of the raw materials capable of being applied. If the preform (a) is formed into a face plate shape (for example, a skin panel) by reinforcing with long fibers having a weight average fiber length of 20 mm or more or continuous fibers and using a high elastic modulus/high thermal resistance resin such as PPS resin as a base of the matrix resin, the preform (b) is formed as a shape such as L channel, C channel, I channel or Ω channel (for example, a stringer), and these preforms are joined to each other to form an integral skin panel structure, it becomes possible to apply it even to a structure requiring high mechanical properties and property of lightening in weight such as a structural material for airplanes. Similarly, use as a structure for vehicles, in which a reinforcement member (for example, an inner frame) is joined to a face plate member (for example, an outer panel), can also be easily realized. In these cases, even if a plurality of preforms (b) as reinforcement members are joined to a preform (a) having a wide face plate shape, it is included in the scope of this disclosure.

To investigate the degree of influence on joint strength depending upon the combination of fiber-reinforced resins, a vibration fusion test was carried out at the combination of preforms as shown in FIG. 1. Using a polyphenylene sulfide having a usual crystallization temperature to preform (a) and preform (b) as the thermoplastic resins (A) and (B), a layer of thermoplastic resin (C) was integrally formed on one surface of the preform (a). As the thermoplastic resin (C), a polyphenylene sulfide resin having a low crystallization temperature was used. In this case, the joint strength was high, and the dispersion of the joint strength was small. In comparison, when a fusion test was carried out preparing completely same preform (a) and preform (b) other than a condition where the thermoplastic resin (C) was not contained, the joint strength was low, and the dispersion of the joint strength was great.

In the above description, the combination of the thermoplastic resin (A), the thermoplastic resin (B) and the thermoplastic resin (C) whose bases are PPS is exemplified. For example, as aforementioned, as this combination, can be exemplified a combination in which the thermoplastic resin (A) and the thermoplastic resin (B) comprise a polyphenylene sulfide and the thermoplastic resin (C) comprises a copolymerized polyphenylene sulfide, and as the copolymerized polyphenylene sulfide, for example, a polymer in which m-phenylene sulfide unit is copolymerized to p-phenylene sulfide unit can be used. Except such a combination of the thermoplastic resin (A), the thermoplastic resin (B) and the thermoplastic resin (C) whose bases are PPS, for example, as aforementioned, an example wherein the thermoplastic resin (A) and the thermoplastic resin (B) comprise a polyamide, and the thermoplastic resin (C) comprises a copolymerized polyamide can also be employed. In such a case using a copolymerized polyamide, as examples of polyamide forming components capable of being copolymerized, can be exemplified amino acids such as 6-aminocapronic acid (excluding a case of a-1), 11-aminoundecanoic acid, 12-aminododecanoic acid and paraminomethyl benzoic acid, lactams such as ε-amino-caprolactam (excluding a case of a-1) and ω-laurolactam, aliphatic, alicyclic and aromatic diamines such as tetramethylene diamine, hexamethylene diamine, 2-methylpentamethylene diamine, undecamethylene diamine, dodecamethylene diamine, 2,2,4-/2,4,4-trimethylhexamethyllene diamine, 5-methylnonamethylene diamine, metaxylene diamine, paraxylylene diamine, 1,3-bis(aminomethyl)cyclohexane, 1,4-bis(aminomethyl)cyclohexane, 1-amino-3-aminomethyl-3,5,5-trimethylcyclohexane, bis(4-aminocyclohexyl)methane, bis(3-methyl-4-aminocyclohexyl)methane, 2,2-bis(4-aminocyclohexyl)propane, bis(aminopropyl)piperazine, and aminoethyl-piperazine, and aliphatic, alicyclic and aromatic dicarboxylic acids such as adipic acid, suberic acid, azelaic acid, sebacic acid, decane dicarboxylic acid, terephthalic acid, isophthalic acid, 2-chloroterephthalic acid 2-methylterephthalic acid, 5-methylisophthalic acid, 5-sodium sulfoisophthalic acid, hexahydroterephthalic acid, and hexahydroisophthalic acid. Further, in accordance with properties required for a molded product to be obtained, a flame retardant, a weather resistance improvement agent, and other than those, an antioxidant, a thermal stabilizer, an ultrasonic absorbent, a plasticizer, a lubricant, a colorant, a compatibilizer, a conductive filler and the like can be added into a resin.

Further, the preform is molded in advance using a first fiber-reinforced resin containing reinforcing fibers having a weight average fiber length of 1 mm or more, preferably it is, for example, either
(1) a molded body with a combination of a mat base material substantially randomly oriented with reinforcing fibers having a weight average fiber length of 1 mm to 50 mm and a resin; or
(2) a molded body reinforced so that continuous fibers are arranged to be extended between arbitrary two end parts of the preform, or
   a molded body combined therewith, and this is defined to satisfy good properties with respect to both of the various mechanical properties and the moldability/formability of the preform itself, ultimately, of a composite molded body as a final molded product.

Namely, as shown in FIG. 2 with respect to a general relationship between length (weight average fiber length, unit: mm) of reinforcing fibers contained in a material for molding in a fiber-reinforced resin (composite) and relative levels of various kinds of properties of a molded fiber-reinforced resin, if the fiber length becomes small, the elastic modulus, the strength and the impact resistance are decreased, but the moldability and the formability become better, and on the contrary, if the fiber length becomes large, the elastic modulus, the strength and the impact resistance are increased but the moldability and the formability deteriorate. To maintain these properties to be high and in a good balance, in particular, it is preferred that reinforcing fibers having a weight average fiber length of 1 mm to 50 mm are contained.

Although in FIG. 2 typical molding processes corresponding to the length of reinforcing fibers contained in a molded material are exemplified (injection molding, press molding, autoclave molding, RTM [Resin Transfer Molding]) (of course, not limited to these molding processes), in case where reinforcing fibers having a weight average fiber length of 1 mm to 50 mm are preferably contained, press molding is suitable.

### INDUSTRIAL APPLICATIONS

The composite molded body and the method of producing the same can be applied to any use of a composite molded body and, in particular, they are suitable for case where a composite molded body required to be produced at a relatively mass production system is produced efficiently at an excellent productivity. As the uses of a composite molded body, for example, exemplified are housings, inner members such as tray and chassis and casings thereof of electric/electronic equipment such as personal computer, display, office automation equipment, portable telephone, portable information terminal, facsimile, compact disc, portable micro disc, portable radio cassette, PDA (portable information terminal such as electronic pocketbook), video camera, digital still camera, optical equipment, audio equipment, air conditioner, illumination equipment, amusement goods, playthings, and other electric household appliances; members for mechanisms; building material such as panel; parts, members and outer panels for automobiles and two-wheeled vehicles such as motor parts, alternator terminal, alternator connector, IC regulator, potentiometer base for light dimmer, parts for suspension, various kinds of valves such as exhaust gas valve, various kinds of pipes for fuel, exhaust and intake systems, air intake nozzle snorkel, intake manifold, various kinds of frames, various kinds of hinges, various kinds of bearings, fuel pump, gasoline tank, CNG tank, engine cooling water joint, carburetor main body, carburetor spacer, exhaust gas sensor, cooling water sensor, oil temperature sensor, brake friction pad wear sensor, throttle position sensor, crank shaft, position sensor, air flow meter, thermostat base for air conditioner, heater hot air flow control valve, brush holder for radiator motor, water pump impeller, turbine vane, parts for wiper motor, distributor, starter switch, starter relay, wire harness for transmission, window washer nozzle, air conditioner panel switch board, fuel system electromagnetic valve coil, connector for fuse, battery tray, AT bracket, head lamp support, pedal housing, handle, door beam, protector, chassis, frame, arm rest, horn terminal, step motor rotor, lamp socket, lamp reflector, lamp housing, brake piston, noise shield, radiator support, spare tire cover, sheet shell, solenoid bobbin, engine oil filter, ignition device case, under cover, scuff plate, pillar trim, propeller shaft, wheel, fender, facer, bumper, bumper beam, bonnet, aero parts, platform, cowl louver, roof, instrument panel, spoiler, and various kinds of modules; and parts, members and outer panels for airplanes such as landing gear pod, winglet, spoiler, edge, rudder, elevator, fairing, and rib.

1. A method of producing a composite molded body wherein a composite molded body is molded by joining a preform (a) pre-molded using a fiber-reinforced thermoplastic resin and a preform (b) pre-molded using a fiber-reinforced thermoplastic resin, comprising:
(1) providing reinforcing fibers having a weight average fiber length of 1 mm or more in at least one of said preforms (a) and (b);
(2) using a thermoplastic resin (A) for said preform (a) and using said thermoplastic resin (A) or a thermoplastic resin (B) for said preform (b);
(3) forming a thin film of a thermoplastic resin (C) on a surface of either said preform (a) or (b), or on surfaces of both of said preforms (a) and (b); and
(4) melting said thermoplastic resin (C) and a part of said preforms (a) and (b) by heating at a condition where said thin film of said thermoplastic resin (C) is placed at a boundary surface of a joint, and molding said composite molded body by the joint due to said melting.

2. The method according to claim 1, wherein said preform containing reinforcing fibers having a weight average fiber length of 1 mm or more is either
(1) a molded body with a combination of a mat base material substantially randomly oriented with reinforcing fibers having a weight average fiber length of 1 mm to 50 mm and a thermoplastic resin; or
(2) a molded body reinforced so that continuous fibers are arranged to be extended between arbitrary two end parts of said preform, or
a molded body combined therewith.

3. The method according to claim 2, wherein said preform containing reinforcing fibers having a weight average fiber length of 1 mm or more is a molded body with a combination of a mat base material substantially randomly oriented with reinforcing fibers having a weight average fiber length of 20 mm to 50 mm and a thermoplastic resin.

4. The method according to claim 1, wherein at least a surface layer part of said preform containing reinforcing fibers having a weight average fiber length of 1 mm or more contains a layer in which reinforcing fibers made of continuous fibers are oriented in one direction.

5. The method according to claim 1, wherein said thermoplastic resin (A), thermoplastic resin (B) and thermoplastic resin (C) have a main component of a crystalline thermoplastic resin, and satisfy:
crystallization temperature of thermoplastic resin (C)<crystallization temperature of thermoplastic resin (A), and
crystallization temperature of thermoplastic resin (C)<crystallization temperature of thermoplastic resin (B).

6. The method according to claim 1, wherein said thermoplastic resin (A) and thermoplastic resin (B) are a thermoplastic resin made of a homopolymer polymerized with a specified monomer, and said thermoplastic resin (C) is a thermoplastic resin made of a copolymer copolymerized with two or more different-kind monomers and contains a same monomer as a monomer in said thermoplastic resin (A) or thermoplastic resin (B) as one of said two or more monomers, or a resin composition blended with said copolymer.

7. The method according to claim 1, wherein said thermoplastic resin (A) and thermoplastic resin (B) have a main component of a polyphenylene sulfide, and said thermoplastic resin (C) comprises a copolymerized polyphenylene sulfide.

8. The method according to claim 7, wherein said copolymerized polyphenylene sulfide comprises a polymer copolymerized with m-phenylene sulfide unit to p-phenylene sulfide unit.

9. The method according to claim 1, wherein said thermoplastic resin (A) and thermoplastic resin (B) have a main component of a polyamide, and said thermoplastic resin (C) comprises a copolymerized polyamide.

10. The method according to claim 1, wherein at least one of said preforms (a) and (b) contains carbon fibers as reinforcing fibers.

11. A composite molded body produced by the method according to claim 1.

12. The method according to claim 2, wherein said thermoplastic resin (A), thermoplastic resin (B) and thermoplastic resin (C) have a main component of a crystalline thermoplastic resin, and satisfy:
crystallization temperature of thermoplastic resin (C)<crystallization temperature of thermoplastic resin (A), and
crystallization temperature of thermoplastic resin (C)<crystallization temperature of thermoplastic resin (B).

13. The method according to claim 3, wherein said thermoplastic resin (A), thermoplastic resin (B) and thermoplastic resin (C) have a main component of a crystalline thermoplastic resin, and satisfy:
crystallization temperature of thermoplastic resin (C)<crystallization temperature of thermoplastic resin (A), and
crystallization temperature of thermoplastic resin (C)<crystallization temperature of thermoplastic resin (B).

14. The method according to claim 4, wherein said thermoplastic resin (A), thermoplastic resin (B) and thermoplastic resin (C) have a main component of a crystalline thermoplastic resin, and satisfy:
crystallization temperature of thermoplastic resin (C)<crystallization temperature of thermoplastic resin (A), and
crystallization temperature of thermoplastic resin (C)<crystallization temperature of thermoplastic resin (B).

15. The method according to claim 2, wherein said thermoplastic resin (A) and thermoplastic resin (B) are a thermoplastic resin made of a homopolymer polymerized with a specified monomer, and said thermoplastic resin (C) is a thermoplastic resin made of a copolymer copolymerized with two or more different-kind monomers and contains a same monomer as a monomer in said thermoplastic resin (A) or thermoplastic resin (B) as one of said two or more monomers, or a resin composition blended with said copolymer.

16. The method according to claim 3, wherein said thermoplastic resin (A) and thermoplastic resin (B) are a thermoplastic resin made of a homopolymer polymerized with a specified monomer, and said thermoplastic resin (C) is a thermoplastic resin made of a copolymer copolymerized with two or more different-kind monomers and contains a same monomer as a monomer in said thermoplastic resin (A) or thermoplastic resin (B) as one of said two or more monomers, or a resin composition blended with said copolymer.

17. The method according to claim 4, wherein said thermoplastic resin (A) and thermoplastic resin (B) are a thermoplastic resin made of a homopolymer polymerized with a specified monomer, and said thermoplastic resin (C) is a thermoplastic resin made of a copolymer copolymerized with two or more different-kind monomers and contains a same monomer as a monomer in said thermoplastic resin (A) or thermoplastic resin (B) as one of said two or more monomers, or a resin composition blended with said copolymer.

18. The method according to claim 5, wherein said thermoplastic resin (A) and thermoplastic resin (B) are a thermoplastic resin made of a homopolymer polymerized with a specified monomer, and said thermoplastic resin (C) is a thermoplastic resin made of a copolymer copolymerized with two or more different-kind monomers and contains a same monomer as a monomer in said thermoplastic resin (A) or thermoplastic resin (B) as one of said two or more monomers, or a resin composition blended with said copolymer.
